(19) United States
(12) Patent Application Publication
(10) Pub. No.: US 2017/0184930 A1
(43) Pub. Date: Jun. 29, 2017

(54) ARRAY SUBSTRATE AND METHOD OF FABRICATING THE SAME

(71) Applicant: SHENZHEN CHINA STAR OPTOELECTRONICS TECHNOLOGY CO., LTD., Shenzhen (CN)

(72) Inventors: Guohe Liu, Shenzhen (CN); Xiufen Zhu, Shenzhen (CN)

(73) Assignee: SHENZHEN CHINA STAR OPTOELECTRONICS TECHNOLOGY CO., LTD., Shenzhen (CN)

(21) Appl. No.: 14/891,695

(22) PCT Filed: Jul. 30, 2015
(86) PCT No.: PCT/CN2015/085513

§ 371 Date: Nov. 17, 2015

(30) Foreign Application Priority Data
Jul. 24, 2015 (CN) 201510442417.8

(51) Int. Cl. G02F 1/1362

(52) U.S. Cl. CPC G02F 1/136209; G02F 1/136277; G02F 2001/136222

(57) ABSTRACT

An array substrate and a method of fabricating the same are disclosed. The method has the following steps of: fabricating a switch array layer on a substrate; forming a color resist layer having a red color filter, a green color filter and a blue color filter on the switch array layer, and a through hole in the color resist layer; forming a transparent conductive layer on the color resist layer; and forming a light shield layer on the transparent conductive layer.

### FIELD OF THE INVENTION

The present invention relates to a liquid crystal display, and more particularly to an array substrate and a method of fabricating the same.

### BACKGROUND OF THE INVENTION

As shown in FIG. 1, an existing array substrate, such that a black matrix on array (BOA) substrate is fabricated by forming a color filter film and a black matrix on the array substrate, comprises: a substrate 11, a first metal layer 12 located on the substrate 11 and including a gate, a gate insulating layer 13 partly located on the first metal layer 12 for isolating the first metal layer 12 from an active layer 14; the active layer 14 partly located on the gate insulating layer for forming a channel; a second metal layer 15 located on the active layer 14 and including a source and a drain; a second insulating layer 16 located on the second metal layer 15; a color resist layer 17 located on the second insulating layer 16, wherein a through hole 18 is formed in the color resist layer and a light shield layer; and a black matrix layer 19 located on the color resist layer 17, wherein a transparent conductive layer 20 is partly located on the black matrix layer 19.

In order to induce the transparent conductive layer to contact with the second metal layer, the through hole is formed in the color resist layer and the light shield layer respectively. Further, after the through hole is formed in the color resist layer, the light shield layer in the through hole is relatively thick accordingly, and the through hole in the light shield layer is unfavorable to fabricate. Next, it will induce a deviation of a position between the through hole in the color resist layer and that in the light shield layer, so as to induce cracks in the subsequent transparent conductive layer easily and influence the display effect.

As a result, it is necessary to provide an array substrate and a method of fabricating the same to solve the problems existing in the conventional technologies.

### SUMMARY OF THE INVENTION

An object of the present invention is to provide an array substrate and a method of fabricating the same, so as to solve a technique problem of the poor display effect due to that a deviation of a position between the through hole in the color resist layer and that in the light shield layer is easily induced and the cracks in the transparent conductive layer is easily generated.

In order to solve the technique problem described above, the present invention is constructed of a method of fabricating an array substrate, which comprises steps of:

fabricating a switch array layer including a first metal layer, an active layer and a second metal layer on a substrate, wherein a plurality of gates are formed by performing a patterning process to the first metal layer, a plurality of sources and drains are formed by performing a patterning process to the second metal layer, and the active layer is used to form a channel;

forming a color resist layer including a red color filter, a green color filter and a blue color filter on the switch array layer, wherein a through hole is formed in the color resist layer;

forming a transparent conductive layer on the color resist layer;

forming a light shield layer on the transparent conductive layer and inside the through hole above the transparent conductive layer; and

forming a first insulating layer on the light shield layer.

In the method of fabricating the array substrate of the present invention, the light shield layer is a black matrix.

In the method of fabricating the array substrate of the present invention, a thickness of the first insulating layer is smaller than or equal to 0.2 μm

In the method of fabricating the array substrate of the present invention, the transparent conductive layer is connected with the second metal layer through the through hole.

In the method of fabricating the array substrate of the present invention, the first insulating layer is made of an inorganic transparent material.

In the method of fabricating the array substrate of the present invention, a second insulating layer is further formed between the switch array layer and the color resist layer.

In order to solve the technique problem described above, the present invention is constructed of a method of fabricating an array substrate, which comprises steps of:

fabricating a switch array layer including a first metal layer, an active layer and a second metal layer on a substrate, wherein a plurality of gates are formed by performing a patterning process to the first metal layer, a plurality of sources and drains are formed by performing a patterning process to the second metal layer, and the active layer is used to form a channel;

forming a color resist layer including a red color filter, a green color filter and a blue color filter on the switch array layer, wherein a through hole is formed in the color resist layer;

forming a transparent conductive layer on the color resist layer; and

forming a light shield layer on the transparent conductive layer.

In the method of fabricating the array substrate of the present invention, the through hole above the transparent conductive layer is also filled with the light shield layer therein.

In the method of fabricating the array substrate of the present invention, the light shield layer is a black matrix.

In the method of fabricating the array substrate of the present invention, the method further comprises a step of: forming a first insulating layer on the light shield layer.

In the method of fabricating the array substrate of the present invention, a thickness of the first insulating layer is smaller than or equal to 0.2 μm.

In the method of fabricating the array substrate of the present invention, the transparent conductive layer is connected with the second metal layer through the through hole.

The present invention further provides an array substrate, comprising:

a substrate;

a switch array layer located on the substrate and including a first metal layer, an active layer and a second metal layer, wherein the first metal layer includes a plurality of gates, the second metal layer includes a plurality of sources and drains, and the active layer is used to form a channel;

a color resist layer located on the switch array layer and including a red color filter, a green color filter and a blue color filter, wherein a through hole is formed in the color resist layer;

a transparent conductive layer located on the color resist layer; and

a light shield layer located on the transparent conductive layer.

In the array substrate of the present invention, the through hole above the transparent conductive layer is also filled with the light shield layer therein.

In the array substrate of the present invention, the light shield layer is a black matrix.

In the array substrate of the present invention, a first insulating layer is further disposed on the light shield layer.

In the array substrate of the present invention, a thickness of the first insulating layer is smaller than or equal to 0.2 μm.

In the array substrate of the present invention, the transparent conductive layer is connected with the second metal layer through the through hole.

According to the array substrate and the method of fabricating the same of the present invention, the black matrix is fabricated after fabricating the transparent conductive layer, so that the transparent conductive layer can be prevented from producing cracks therein.

### DESCRIPTION OF THE DRAWINGS

FIG. 1 is a structural schematic diagram of an array substrate of an existing technique.

FIG. 2 is a structural schematic diagram of an array substrate of the present invention.

FIG. 3 is a schematic diagram of an electric field intensity changing with an insulating layer thickness.

FIG. 4 is a waveform diagram of insulating layers with different thicknesses of the present invention affecting on an electric field intensity.

FIG. 5 is a flow chat of a method of fabricating an array substrate of the present invention.

FIG. 6 is a structural schematic diagram of a liquid crystal display panel of the present invention.

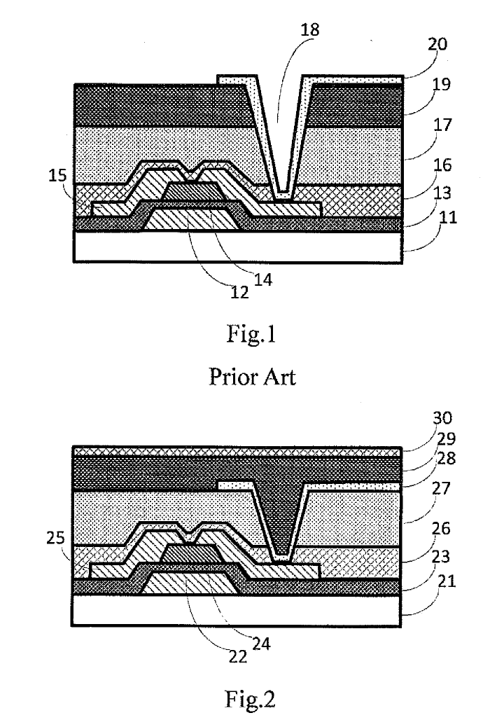

### DETAILED DESCRIPTION OF THE PREFERRED EMBODIMENTS

The following description of the embodiments with reference to the appended drawings is used for illustrating specific embodiments, which may be used for carrying out, of the present invention. The directional terms described by the present invention, such as upper, lower, front, back, left, right, inner, outer, side, and etc., are only directions by referring to the accompanying drawings. Thus, the used directional terms are used to describe and understand the present invention, but the present invention is not limited thereto. In figures, elements with similar structures are indicated as the same numbers.

Please referring to FIG. 2, FIG. 2 is a structural schematic diagram of an array substrate of the present invention.

As shown in FIG. 2, the array substrate of the present invention comprises: a substrate 21, a switch array layer, a color resist layer 27, a transparent conductive layer 28 and a light shield layer 29.

The switch array layer is located on the substrate 21 and includes a plurality of thin film transistors which specifically includes: a first metal layer 22, a gate insulating layer 23, an active layer 24 and a second metal layer 25.

The first metal layer 22 is located on the substrate 21 and may include a plurality of gates. The gate insulating layer 23 is located on the first metal layer 21. The active layer 24 is partly located on the gate insulating layer 23. The second metal layer 25 is located on the active layer 24. The color resist layer 27 is located on the second metal layer 25 and includes a plurality of color filter resist. A through hole may be disposed in the color resist layer 27. The transparent conductive layer 28 is connected with the second metal layer 25 through the through hole.

The transparent conductive layer 28 is located on the color resist layer 27. The light shield layer 29 is located on the transparent conductive layer 28. The light shield layer 29 may be a black matrix.

It is only required to fabricating the through hole in the color resist layer by that the light shield layer is fabricated after fabricating the transparent conductive layer, such that the fabricating process is saved, the problem that the deviation is easily induced by fabricating the through hole simultaneously in the color resist layer and the light shield layer is avoided, and the transparent conductive layer are avoided generating cracks therein.

Preferably, the through hole above the transparent conductive layer 28 is also filled with the light shield layer therein.

Since the transparent conductive layer can be translucent, a light leakage occurs at an edge of the through hole accordingly. The phenomenon that the light leakage occurs at the edge of the through hole may be avoided by which, the through hole is also filled with the light shield layer therein, thereby better improving display effect. It is appreciated that the through hole is filled with the black matrix therein until the through hole being filling-up, which may make a surface of the through hole more smooth and better improve the display effect.

Preferably, a first insulating layer 30 is further disposed on the light shield layer 29. The first insulating layer 30 prevents from the material inside the light shield layer or color resist layer being easily volatilized in high temperature processes to produce bubbles, so as to influence the display effect. The material of the first insulating layer is primary an inorganic material, such as silicon nitride (SiNx), and etc.

Further, a thickness of the first insulating layer 30 is smaller than or equal to 0.2 μm. Since the liquid crystal electric field intensity in vertical direction is reduced along with increasing of the thickness of the first insulating layer, in practice though, it may offset the electric field reducing effect due to the increasing of the thickness of the first insulating layer by adjusting a liquid crystal driving voltage. However, the energy consumption is increased so as to increase the cost of production. Through experiments, it is found that when the thickness of the first insulating layer is provided in the above range, the energy consumption is reduced and the electric field intensity is avoid affecting simultaneously. The thickness of the first insulating layer 30 is preferred smaller than or equal to 0.1 μm.

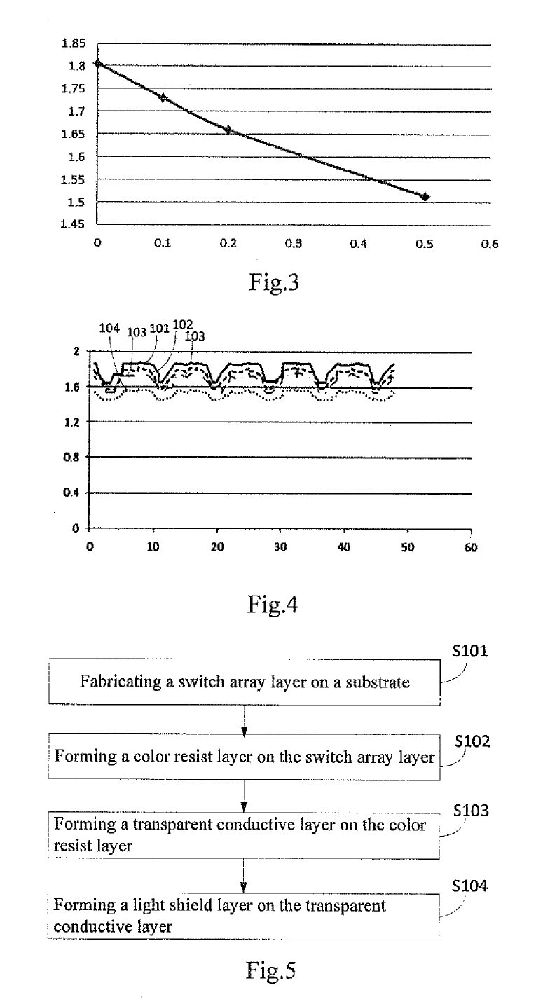

A schematic diagram of an electric field intensity changing with an insulating layer thickness is as shown in FIG. 3. In FIG. 3, the abscissa indicates the thickness of the insulating layer (in units of μm), the ordinate represents the electric field intensity (in units of V/μm). The specific values of the electric field intensity changing with the insulating layer thickness is shown in the following table:

TABLE 1

| Insulating layer | | Electric field |
|---|---|---|
| thickness | Electric field intensity | reducing |
| (μm) | (V/μm) | (%) |
| 0 | 1.806 | 0.00% |
| 0.1 | 1.73 | 4.20% |
| 0.2 | 1.66 | 8.08% |
| 0.5 | 1.514 | 16.17% |

As shown in FIG. 3 and Table 1, it is not difficult to see when the thickness of the insulating layer is equal to 0.2 μm, the electric field intensity reduces 8.08%; when the thickness of the insulating layer is equal to 0.5 μm, the electric field intensity reduces 16.2%. When the thickness of the insulating layer is larger than to 0.2 μm, the electric field intensity becomes lager decline, but when the thickness of the insulating layer is smaller than and equal to 0.2 μm, the electric field strength decreases slowly to meet the normal process requirements. In particular, when the thickness of the insulating layer is smaller than and equal to 0.1 μm, it does not basically affect the electric field intensity.

FIG. 4 shows a waveform diagram of insulating layers with different thicknesses, as shown in FIG. 4. In FIG. 4, the abscissa indicates the position in the longitudinal direction of the liquid crystal panel of the insulating layer (in units of μm) and the ordinate represents the electric field intensity (in units of V/μm). Number 101 represents a waveform schematic diagram of the electric field intensity without disposing the insulating layer. Number 102 represents a waveform schematic diagram of the electric field intensity when the thickness of the insulating layer is 1000 Å. Number 103 represents a waveform schematic diagram of the electric field intensity when the thickness of the insulating layer is 2000 Å. Number 104 represents a waveform schematic diagram of the electric field intensity when the thickness of the insulating layer is 5000 Å.

From this, when the thickness of the insulating layer is smaller than and equal to 0.1 μm, the extent of reducing the electric field intensity is very small.

Preferably, a second insulating layer 26 is further formed between the switch array layer and the color resist layer 27. It means that the second insulating layer 26 is disposed between the color resist layer 27 and the second metal layer 25. The second insulating layer 26 is used to isolate the second metal layer from the color resist layer and to prevent from the second metal layer being oxidized.

Please referring to FIG. 5, FIG. 5 is a flow chat of a method of fabricating an array substrate of the present invention.

A method of fabricating an array substrate of the present technique includes the following steps of:

S101: forming a switch array layer on the substrate

The switch array layer includes a plurality of thin film transistors, wherein the specific process method of the switch array layer is:

S111: forming a first metal layer on the substrate, wherein a plurality of gates are formed by performing a patterning process to the first metal layer

The step S111 is specifically that performing an exposure, lithography and etching to the first metal layer to form gates by a mask plate with patterns. The first metal layer in the portion other than the gate portion is etched away. The material of the metal layer may be chromium, molybdenum, aluminum or copper, etc.

S112: forming an active layer on the first metal layer

The active layer is used to form a channel between drains and sources. A material of the active layer is such as amorphous silicon material.

S113: forming a second metal layer on the active layer

The drains and the sources are formed by performing an exposure, lithography and etching to the second metal layer by a mask plate with patterns. The second metal layer in the portion other than the drains and sources portion is etched away, wherein the number of the gates is fitted to that of the sources and the drains.

Preferably, before fabricating the active layer, the method further includes:

Forming a gate insulating layer on the gates and on the substrate which is not covered with the gates.

S102: forming a color resist layer on the switch array layer

A through hole may be formed in the color resist layer, and the transparent conductive layer is connected with the second metal layer through the through hole. The color resist layer may include a red color filter, a green color filter and a blue color filter.

S103: forming a transparent conductive layer on the color resist layer

The sputtering method may be used to form the transparent conductive layer on a black matrix layer. The transparent conductive layer includes a pixel electrode.

S104: forming a light shield layer on the transparent conductive layer

The light shield layer may be a black matrix. The transparent conductive layer is coated with a light shield material by a mask plate with patterns, and an exposure and lithography is performed to the light shield material to form the black matrix.

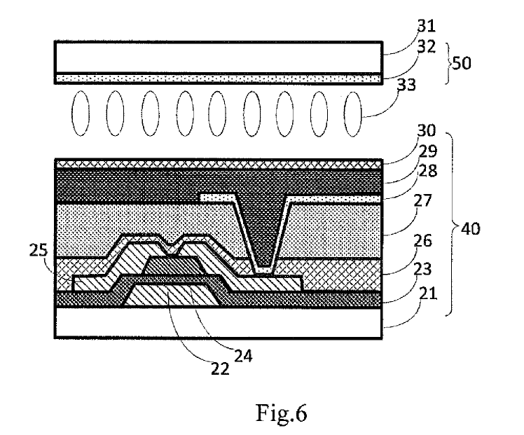

Please referring to FIG. 6, FIG. 6 is a structural schematic diagram of a liquid crystal display panel of the present invention.

The liquid crystal display panel of the present invention is shown as FIG. 6 and includes: a first substrate 40, a second substrate 50, a liquid crystal layer 33 located between the first substrate 40 and the second substrate 50. The second substrate 50 includes a substrate 31 and another transparent conductive layer 32. The transparent conductive layer includes a common electrode. The first substrate 40 is such as a BOA array substrate and includes a substrate 21, a switch array layer, a color resist layer 27, a transparent conductive layer 28 and a light shield layer 29.

The switch array layer is located on the substrate 21 and includes a plurality of thin film transistors, which specifically includes: a first metal layer 22, a gate insulating layer 23, an active layer 24 and a second metal layer 25.

The first metal layer 22 is located on the substrate 21 and may include a plurality of gates. The gate insulating layer 23 is located on the first metal layer 21. The active layer 24 is partly located on the gate insulating layer 23. The second metal layer 25 is located on the active layer 24. The color resist layer 27 is located on the second metal layer 25 and includes a plurality of color filter resist. A through hole may be disposed in the color resist layer 27. The transparent conductive layer 28 is connected with the second metal layer 25 through the through hole.

The transparent conductive layer 28 is located on the color resist layer 27. The light shield layer 29 is located on the transparent conductive layer 28. The light shield layer 29 may be a black matrix.

It is only required to fabricating the through hole in the color resist layer by that the light shield layer is fabricated after fabricating the transparent conductive layer, such that the fabricating process is saved, the problem that the deviation is easily induced by fabricating the through hole simultaneously in the color resist layer and the light shield layer is avoided, and the transparent conductive layer are avoided generating cracks therein.

Preferably, the through hole above the transparent conductive layer 28 is also filled with the light shield layer therein.

Since the transparent conductive layer can be translucent, a light leakage occurs at an edge of the through hole accordingly. The phenomenon that the light leakage occurs at the edge of the through hole may be avoided by which, the through hole is also filled with the light shield layer therein, thereby better improving display effect. It is appreciated that the through hole is filled with the black matrix therein until the through hole being filling-up, which may make a surface of the through hole more smooth and better improve the display effect.

Preferably, a first insulating layer 30 is further disposed on the light shield layer 29. The first insulating layer 30 prevents from the material inside the light shield layer or color resist layer being easily volatilized in high temperature processes to produce bubbles, so as to influence the display effect.

Further, a thickness of the first insulating layer is smaller than or equal to 0.2 μm, and is preferred smaller than or equal to 0.1 μm.

Preferably, a second insulating layer 26 is further formed between the switch array layer and the color resist layer 27. It means that the second insulating layer 26 is disposed between the color resist layer 27 and the second metal layer 25. The second insulating layer 26 is used to isolate the second metal layer from the color resist layer and to prevent from the second metal layer being oxidized.

In the array substrate and fabricating the same of the present invention, the fabricating process is saved, the cost of production is reduced and the display effect is improved by fabricating the black matrix before fabricating the color resist layer.

According to the above, although the present invention has been described in a preferred embodiment described above, preferred embodiments described above are not intended to limit the invention, one of ordinary skill in the art without departing from the spirit and scope of the invention within, can make various modifications and variations, so the range of the scope of the invention defined by the claims prevail.

What is claimed is:

1. A method of fabricating an array substrate, comprising:
fabricating a switch array layer including a first metal layer, an active layer and a second metal layer on a substrate, wherein a plurality of gates are formed by performing a patterning process to the first metal layer, a plurality of sources and drains are formed by performing a patterning process to the second metal layer, and the active layer is used to form a channel;
forming a color resist layer including a red color filter, a green color filter and a blue color filter on the switch array layer, wherein a through hole is formed in the color resist layer;
forming a transparent conductive layer on the color resist layer;
forming a light shield layer on the transparent conductive layer and inside the through hole above the transparent conductive layer; and
forming a first insulating layer on the light shield layer.

2. The method of fabricating the array substrate according to claim 1, wherein the light shield layer is a black matrix.

3. The method of fabricating the array substrate according to claim 1, wherein a thickness of the first insulating layer is smaller than or equal to 0.2 μm.

4. The method of fabricating the array substrate according to claim 1, wherein the transparent conductive layer is connected with the second metal layer through the through hole.

5. The method of fabricating the array substrate according to claim 1, wherein the first insulating layer is made of an inorganic transparent material.

6. The method of fabricating the array substrate according to claim 1, wherein a second insulating layer is further formed between the switch array layer and the color resist layer.

7. A method of fabricating an array substrate, comprising:
fabricating a switch array layer including a first metal layer, an active layer and a second metal layer on a substrate, wherein a plurality of gates are formed by performing a patterning process to the first metal layer, a plurality of sources and drains are formed by performing a patterning process to the second metal layer, and the active layer is used to form a channel;
forming a color resist layer including a red color filter, a green color filter and a blue color filter on the switch array layer, wherein a through hole is formed in the color resist layer;
forming a transparent conductive layer on the color resist layer; and
forming a light shield layer on the transparent conductive layer.

8. The method of fabricating the array substrate according to claim 7, wherein the through hole above the transparent conductive layer is also filled with the light shield layer therein.

9. The method of fabricating the array substrate according to claim 7, wherein the light shield layer is a black matrix.

10. The method of fabricating the array substrate according to claim 7, wherein the method further comprises a step of: forming a first insulating layer on the light shield layer.

11. The method of fabricating the array substrate according to claim 10, wherein a thickness of the first insulating layer is smaller than or equal to 0.2 μm.

12. The method of fabricating the array substrate according to claim 7, wherein the transparent conductive layer is connected with the second metal layer through the through hole.

13. An array substrate, comprising:
a substrate;
a switch array layer located on the substrate and including a first metal layer, an active layer and a second metal layer, wherein the first metal layer includes a plurality of gates, the second metal layer includes a plurality of sources and drains, and the active layer is used to form a channel;
a color resist layer located on the switch array layer and including a red color filter, a green color filter and a blue color filter, wherein a through hole is formed in the color resist layer;
a transparent conductive layer located on the color resist layer; and
a light shield layer located on the transparent conductive layer.

14. The array substrate according to claim 13, wherein the through hole above the transparent conductive layer is also filled with the light shield layer therein.

15. The array substrate according to claim 13, wherein the light shield layer is a black matrix.

16. The array substrate according to claim 13, wherein a first insulating layer is further disposed on the light shield layer.

17. The array substrate according to claim 16, wherein a thickness of the first insulating layer is smaller than or equal to 0.2 μm.

18. The array substrate according to claim 13, wherein the transparent conductive layer is connected with the second metal layer through the through hole.
